(19) United States
(12) Patent Application Publication
(10) Pub. No.: US 2008/0162767 A1
(43) Pub. Date: Jul. 3, 2008

(54) 4X Framer/Deframer Module For PCI-Express and PCI-Express Framer/Deframer Device Using The Same

(75) Inventors: Sang-Wook CHO, Ansan-si (KR); Jin-Kyu Kim, Ansan-si (KR); Sung-Ju Park, Ansan-si (KR); Hyun-Bean Yi, Ansan-si (KR); Chang-Won Park, Suwon-si (KR); Ki-Man Jeon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Korea Electronics Technology Institute, Seongnam-si (KR)

(21) Appl. No.: 11/926,446

(22) Filed: Oct. 29, 2007

(30) Foreign Application Priority Data
Dec. 28, 2006 (KR) 10-2006-0136303

(51) Int. Cl. G06F 13/14

(52) U.S. Cl. 710/305

(57) ABSTRACT

Provided is a 4× framer/deframer module for PCI-Express and a framer/deframer device using the same. In the PCI-Express for high-rate data processing, delimiter and pad processing, and 4× framer shifting and arrangement/reverse arrangement for framing/deframing a frame format are performed to achieve a structure that facilitates reconfiguration and expansion, for example, a pipeline structure, so that the 4× framer/deframer module can operate without delay within a 250 MHz clock even when expansion to 32× is made.

### CROSS-REFERENCE TO RELATED APPLICATIONS

This application claims priority under 35 U.S.C. §119 to Korean Patent Application No. 0136303/2006, filed on Dec. 28, 2006, the disclosure of which is incorporated herein by reference in its entirety.

### BACKGROUND OF THE INVENTION

1. Field of the Invention

The present disclosure relates to a 4× framer/deframer module for PCI-Express and a framer/deframer device using the same, and more particularly, to a 4× framer-deframer module for PCI-Express for high-rate data processing, which is configured to perform delimiter and pad processing, and 4× framer shifting and arrangement/reverse arrangement for framing/deframing a frame format to achieve a structure that facilitates reconfiguration and expansion, for example, a pipeline structure, so that the 4× framer/deframer module can operate without delay within a 250 MHz clock even when expansion to 32× is made, and a framer/deframer device using the same.

2. Description of the Related Art

As information communications technologies are developed at such a high speed, and demands for Internet services sharply increase, significant increases in data processing rates and throughput are being required.

In this respect, the need for a high-speed data input/output (I/O) technology is increasing to overcome limitations in improvement of system-performance due to a high performance server, a mass storage device, or a shared bus structure.

Particularly, to overcome the limitation of the shared bus, a variety of methods have been being proposed and implemented.

A PCI-Express bus, which is called a third generation I/O, was proposed in a consortium formed by companies including Intel, Compaq, Hewlett-Packard (HP), and Microsoft. The PCI-Express bus technology focuses on performance improvement inside a system.

The PCI-Express bus technology will now be described in more detail.

The PCI-Express uses a packet-based serial switch structure, not parallel-shared buses, and supports a peer-to-peer (P2P) structure, not a client-server structure. The PCI-Express is designed for a system area network or storage area network (SAN). Since the PCI-Express includes every mechanism of PCI buses, the related-art PCI devices can also be used in the PCI-Express. Specifications of the PCI are shown in the following table 1.

TABLE 1

| Category | Specifications |
|---|---|
| Coverage | Inside of system |
| Transmission mode | Full-duplex |
| Link length | Up to 20 cm |
| Link width | 1, 2, 4, 8, 12, 16, 32x |
| Signaling rate | 2.5 Gbps |
| Source data bandwidth | 5 Gbps to 160 Gbps |
| System hierarchy | P2P, memory map tree |
| System software interface | Low level load/store |

The PCI-Express includes a transaction layer, a data link layer, and a physical layer, and uses an 8b/10b encoder/decoder, and a serializer/deserializer (hereinafter, referred to as a SerDes).

In this case, a transmitter converts parallel data into serial data after encoding, and transmits. A receiver converts the serial data into parallel data, and decodes the data for processing.

To receive and transmit a packet, a process of adding or deleting a delimiter, i.e., a specific pattern indicating a start and an end of the packet is required.

Delimiter symbols and a pad PAD used in the PCI-Express are shown in the following table 2.

TABLE 2

| PCI-Express Symbol | Code Name | K | Hex Value |
|---|---|---|---|
| STP | K27.7 | 1 | FB |
| SDP | K.28.2 | 1 | 5C |
| END | K29.7 | 1 | FD |
| EDB | K30.7 | 1 | FE |
| PAD | K23.7 | 1 | F7 |

In table 2, ‘Code Name’ denotes a name of 8b/10b transmission code. If ‘K’ is ‘1’, it denotes a special control character, and if ‘K’ is ‘0’, it denotes a data character. As for ‘PCI-Express Symbol’, ‘STP’ denotes a start of a transaction-layer packet, ‘SDP’ denotes a start of a data-link-layer packet, ‘END’ denotes an end of a good packet, and ‘EDB’ denotes an end of a bad packet. ‘PAD’ denotes a pad.

This PCI-Express bus technology focuses only on performance improvement inside a system. To obtain improved performance in connection between the inside and the outside of the system, MindSpeed Technology, Lattice Semiconductor, Cypress Semiconductor etc have developed SerDes chips or cores. However, these SerDes Chips or cores do not support a framing/deframing function in 4× or more.

This will now be described in more detail.

FIGS. 1A and 1B are views showing exemplary structures of the related art PCI-Express 4× frame format, and FIGS. 2A through 2D are view showing exemplary structures of the related-art PCI-Express 12× frame format.

In FIGS. 1A and 1B, or FIGS. 2A through 2D, ‘MSB’ denotes a most significant byte, ‘LSB’ denotes a least significant byte, and “Time” indicates that a clock advances downwardly.

A data link packet of the PIC-Express is fixed to 6 bytes, and a transaction packet is variable in length, and may be longer or shorter than shown in FIGS. 1 and 2. The transaction packet has a 4n+2 byte size including a header field, a data payload field, and a cyclic redundancy check (CRC) field.

Thus, the PCI-Express frame formats shown in FIGS. 1A and 1B or FIGS. 2A through 2D maintain multiples of 4 bytes including 1 byte of a start delimiter Start and 1 byte of an end delimiter End.

As shown in FIGS. 1A and 1B, in the case of the 4× frame format, a start delimiter and an end delimiter must be placed at a 1^{st} lane (lane 1) and a 4^{th} lane (lane 4), respectively. As shown in FIGS. 2A through 2D, in the case of the 12× frame format, a start delimiter must be placed at a 1^{st} lane (lane 1), an end delimiter must be placed at a 4^{th}, 8^{th} or 12^{th} lane (lane 4, lane 8, or lane 12), and the remaining empty regions must be padded.

FIGS. 3A and 3B are views showing exemplary framing/deframing using the related-art 4×PCI-Express framer/deframer device.

As shown, framing/deframing is performed on a 4× frame by the related art 4×PCI-Express framer/deframer device.

Referring to FIG. 3A showing framing, arrangement and delimiter insertion are performed by a 4× PCI-Express framer/deframer device 100. Data is shifted forwardly by one byte because of the insertion of a start delimiter. Thus, an LSB is moved to a region of an MSB of the next row.

Referring to FIG. 3B showing deframing, rearrangement and delimiter deletion are performed by the 4× PCI-Express framer/deframer device 100. The start delimiter and the end delimiter are deleted, and thus the data is rearranged and shifted backwardly by one byte. Accordingly, an MSB is moved to a region of an LSB of the previous row.

For the 4× frame, the framing/deframing can be performed by arrangement/rearrangement, and insertion/deletion of delimiters.

However, as shown in FIGS. 2A through 2D, in the case of 12× frame or greater, the position of the end delimiter is not fixed, and addition or deletion of pads must be considered.

For more than 4× multiples lanes, a specific delimiter must be added or deleted for a corresponding lane, which requires functions such as packet rearrangement and padding. However, these functions are not yet supported in implementing framing/deframing of multiple lanes supported by the PCI-Express.

Also, for the more than 4× multiple lanes, there are limitations in reconfiguration and expansion because not only the delimiter processing and padding but also forward arrangement/reverse arrangement for framing or deframing of a frame format cannot be performed.

The related art 4× PCI-Express framer/deframer device 100 is applicable only for the 4× frame format, and is inapplicable for multiple lanes of 8×, 12× or more. Although processing can be performed by newly designing the related PCI-Express framer/deframer device 100 whenever lanes increase, needs for a 4× PCI-Express framer/deframer device expansible to multiple lanes are increasing with regard to reusability, and reduction of a design time and cost.

### SUMMARY

Therefore, an object of the present invention is to provide a 4× framer-deframer module for PCI-Express for high-rate data processing, which is configured to perform delimiter and pad processing, and 4× framer shifting and arrangement/reverse arrangement for framing/deframing a frame format to achieve a structure that facilitates reconfiguration and expansion, for example, a pipeline structure, so that the 4× framer/deframer module can operate without delay within a 250 MHz clock even when expansion to 32× is made, and a framer/deframer device using the same.

To achieve these and other advantages and in accordance with the purpose(s) of the present invention as embodied and broadly described herein, a 4× framer/deframer module for PCI-Express for framing in accordance with an aspect of the present invention comprises: a framing input-data receiver configured to receive a 32-bit data input signal; a shifter configured to shift the 32-bit data input signal, and output a 24-bit shift signal and an 8-bit shift-out signal, which is a least significant byte (LSB) of the 32-bit data input signal; a framing base-signal generator configured to receive an 8-bit shift-in signal, designate the 8-bit shift-in signal as a most significant byte (MSB), and add the 24-bit shift signal of the shifter thereto to generate a 32-bit framing base signal; a framing controller configured to generate a framing control signal for controlling insertion of a delimiter or a pad signal with respect to the framing base signal; and a framing data buffer configured to operate the framing base signal on the basis of the framing control signal to output a 32-bit PCI-Express frame format signal.

The framing controller may control such that the 8-bit shift-out signal is input as the 8-bit shift-in signal.

The framing controller may control such that an 8-bit shift-out signal of another external 4× framer/deframer module for PCI-Express is input as the 8-bit shift-in signal.

The framing control signal may include a delimiter control signal for insertion of the delimiter, and the framing data buffer may multiplex a corresponding lane of the framing base signal on the basis of the delimiter control signal to output the PCI-Express frame format signal.

The delimiter control signal may be a start delimiter control signal, or an end delimiter control signal and the framing data buffer may multiplex an MSB of the framing base signal on the basis of the start delimiter control signal, or multiplex an LSB of the framing base signal on the basis of the end delimiter control signal to output the PCI-Express frame format signal.

The framing control signal may include a pad control signal for insertion of the pad signal, and the framing data buffer may multiplex a corresponding lane of the framing base signal on the basis of the pad control signal to output the PCI-Express frame format signal.

The framing controller may generate the framing control signal on the basis of a mode control signal that is generated according to disposition of the 4× framer/deframer module for PCI-Express.

The framing controller may generate the framing control signal on the basis of a control signal from a PCI-Express data link layer or a transaction layer.

The framing base signal generator may be a 32-bit register.

The framing data buffer may include: an 8-bit register configured to store an MSB of the framing base signal; an end delimiter multiplexer configured to multiplex an LSB of the framing base signal on the basis of the framing control signal; a start delimiter multiplexer configured to multiplex the MSB of the 8-bit resistor or the framing base signal on the basis of the framing control signal; a first register configured to store a framing intermediate signal that is obtained by multiplexing the framing base signal using the end-delimiter multiplexer and the start delimiter multiplexer; a pad multiplexer configured to multiplex a portion of lanes of the framing intermediate signal on the basis of the framing control signal; a second register configured to store a framing result signal obtained by multiplexing the framing intermediate signal using the pad multiplexer; and a framing buffer configured to output the 32-bit PCI-Express frame format signal from the framing result signal of the second register.

In accordance with another aspect of the present invention, there is provided a framer/deframer device for PCI-Express for framing comprises a plurality of 4× framer/deframer modules for PCI-Express, wherein the plurality of 4× framer/deframer modules for PCI-Express are connected into a chain type such that a shift-out signal of the 4× framer/deframer module for PCI-Express is applied as a shift-in signal of the neighboring 4× framer/deframer module for PCI-Express.

In accordance with another aspect of the present invention, there is provided a 4× framer/deframer module for PCI-Express for deframing comprises: a deframing input-data receiver configured to receive a 32-bit PCI-Express frame format input signal; a shifter configured to shift the 32-bit PCI-Express frame format input signal to output a most significant byte (MSB) of the 32-bit PCI-Express frame format input signal as an 8-bit shift-out signal, and output a remaining 24-bit shift signal; a deframing base-signal generator configured to receive an 8-bit shift-in signal and add the 8-bit shift-in signal as a least significant bit (LSB) to the 24-bit shift signal to generate a 32-bit deframing base signal; a framing controller configured to generate a deframing control signal for controlling deletion of a delimiter or a pad signal with respect to the deframing base signal; and a deframing data buffer configured to operate the deframing base signal on the basis of the deframing control signal to output a 32-bit deframing data signal.

The deframing controller may control such that the 8-bit shift-out signal is input as the 8-bit shift-in signal.

The deframing controller may control such that an 8-bit shift-out signal of another external 4× framer/deframer module for PCI-Express is input as the 8-bit shift-in signal.

The deframing control signal may include a shift control signal for deletion of the delimiter or the pad signal, and the deframing data buffer may multiplex an LSB of the framing base signal on the basis of the shift control signal to output the deframing data signal.

The deframing controller may generate the deframing control signal on the basis of a mode control signal that is generated according to deposition of the 4× framer/deframer module for PCI-Express.

The deframing controller may transmit status information of the deframing data signal to a PCI-Express data link layer or a transaction layer.

The deframing base signal generator may be a 32-bit register.

The deframing data buffer may include: a first register configured to store the deframing base signal; a shift multiplexer configured to multiplex an LSB of the deframing base signal and an LSB of the first register on the basis of the deframing control signal; a second register configured store, as the deframing data signal, a signal obtained by multiplexing the deframing base signal of the first register using the shift multiplexer; and a deframing buffer configured to output the deframing data signal.

In accordance with another aspect of the present invention, there is provided, a framer-deframer device for PCI-Express for deframing comprises a plurality of 4× framer/deframer modules for PCI-Express, wherein the plurality of 4× framer/deframer modules for PCI-Express are connected into a chain type such that a shift-out signal of the 4× framer/deframer module for PCI-Express is applied as a shift-in signal of the neighboring 4× framer/deframer module for PCI-Express.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIGS. 1A and 1B are views showing an exemplary structure of the related art PCI-Express 4× frame format;

FIGS. 2A through 2D are views showing an exemplary structure of the related art PCI-Express 12× frame format;

FIGS. 3A and 3B are views showing exemplary framing or deframing using the related art PCI-Express framer/deframer device;

FIG. 4 is a block diagram of a 4× framer/deframer module for PCI-Express for framing according to an embodiment of the present invention;

FIG. 5 is a block diagram of a framing data buffer of a 4× framer/deframer module for PCI-Express for framing according to an embodiment of the present invention;

FIGS. 6 and 7 are views showing implementation examples of a 4× framer/deframer module for PCI-Express for framing according to an embodiment of the present invention;

FIG. 8 is a block diagram of a 4× framer/deframer module for PCI-Express for deframing according to an embodiment of the present invention;

FIG. 9 is a block diagram of a deframing data buffer of a 4× framer/deframer module for PCI-Express for deframing according to an embodiment of the present invention;

FIGS. 10 and 11 are views showing implementation examples of a 4× framer/deframer module for PCI-Express for deframing according to an embodiment of the present invention;

FIG. 12 is a view showing an example of implementing a 32× framer/deframer device for PCI-Express by connecting eight 4× framer/deframer modules for PCI-Express for framing according to an embodiment of the present invention; and

FIG. 13 is a view showing an example of implementing a 32× PCI-Express framer/deframer device by connecting eight 4× framer/deframer modules for PCI-Express for deframing according to an embodiment of the present invention.

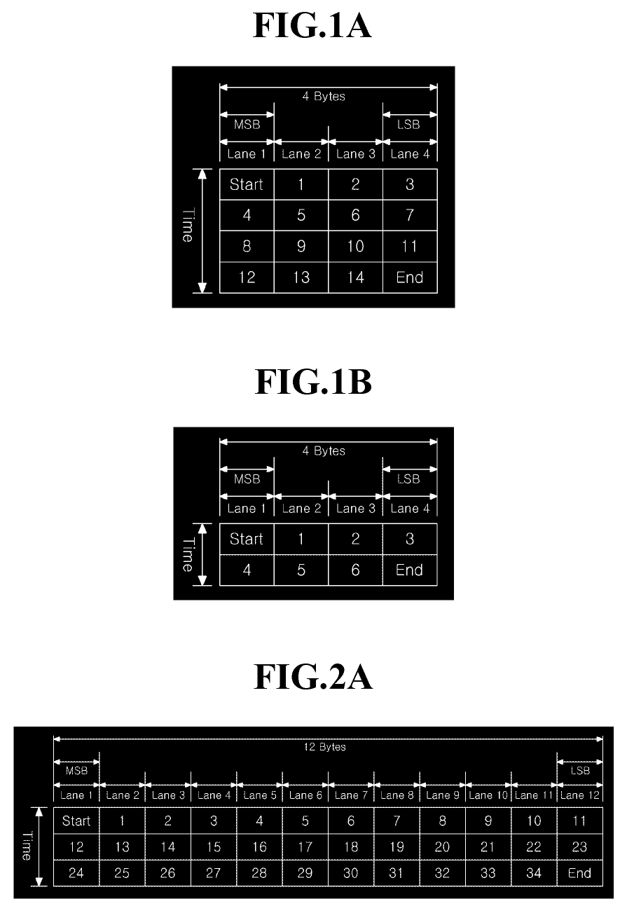

### DETAILED DESCRIPTION OF EMBODIMENTS

Hereinafter, specific embodiments will be described in detail with reference to the accompanying drawings.

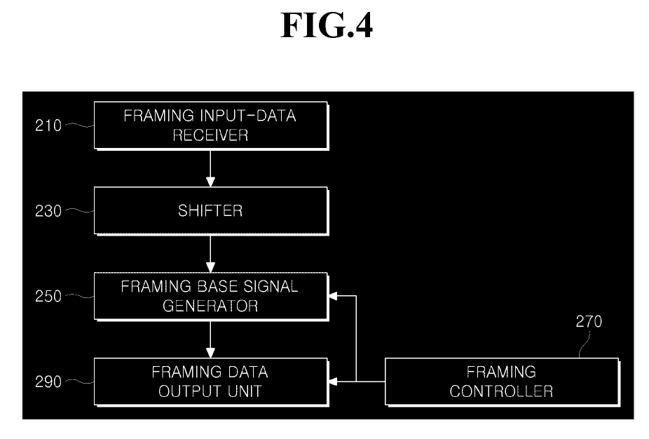

FIG. 4 is a block diagram of a 4× framer/deframer module for PCI-Express for framing according to an embodiment of the present invention.

As shown, the 4× framer/deframer module for PCI-Express according to an embodiment of the present invention includes a framing input-data receiver 210, a shifter 230, a framing base-signal generator 250, a framing controller 270, and a framing data buffer 290.

The framing input-data receiver 210 receives a 32-bit data input signal.

The 32-bit data input signal is input from, e.g., a data link layer, a transaction layer, or an InfiniBand link layer of the PCI-Express.

The shifter 230 is configured to shift the 32-bit data input signal received by the framing input-data receiver 210, and output a 24-bit shift signal and an 8-bit shift-out signal. The 8-bit shift-output signal is 8 bits of a least significant byte (LSB) of the 32-bit data input signal.

The framing base-signal generator 250 is configured to receive an 8-bit shift-in signal, designate the signal as a most significant byte (MSB), and add the 24-bit shift signal of the shifter 230 to generate a 32-bit framing base signal.

That is, the MSB of the 32-bit framing base signal is the 8-bit shift-in signal, and the remaining 3 bytes are set to first three bytes of the 32-bit data input signal received by the framing input-data receiver 210.

The framing base-signal generator 250 is configured to store and output a 4-byte, i.e., 32-bit framing base signal. Thus, the framing base-signal generator 250 can be implemented using a 32-bit register.

The framing controller 270 is configured to generate a framing control signal that controls insertion of a delimiter or a pad signal with respect to the framing base signal of the framing base-signal generator 250.

The delimiter may be a start delimiter or an end delimiter described above.

When the 4× framer/deframer module for PCI-Express according to an embodiment of the present invention is used singly, an 8-bit shift-out signal and an 8-bit shift-in signal may be identical.

That is, the 8-bit shift-out signal in the shifter 230 may be used as the 8-bit shift-in signal. In this case, the framing controller 270 may control such that an 8-bit shift-out signal of the shifter 230 is input to the framing base-signal generator 250 as an 8-bit shift-in signal.

Also, a plurality of 4× framer/deframer modules for PCI-Express according to an embodiment of the present invention may be connected and used, particularly, for multiple lanes such as 8× or 16× lanes. In this case, the framing controller 260 may control such that an 8-bit shift-out signal of another external 4× framer/deframer module for PCI-Express is input to the framing base-signal generator 250 as an 8-bit shift-in signal.

The framing controller 270 may generate a framing control signal on the basis of a mode control signal that is generated depending on disposition of the 4× framer/deframer modules for PCI-Express according to an embodiment of the present invention. Such a mode control signal will be described later.

Also, the framing controller 270 may generate a framing control signal on the basis of a control signal from a PCI-Express data link layer or a transaction layer. The control signal from the PCI-Express data link layer or the transaction layer will be described later.

The framing data buffer 290 is configured to operate the framing base signal of the framing base-signal generator 250 on the basis of the framing control signal of the framing controller 270 to output a 32-bit PCI-Express frame format signal.

The framing control signal may be, for example, a delimiter control signal for insertion of a delimiter. In this case, the framing data buffer 290 multiplexes a corresponding lane of the framing base signal on the basis of the delimiter control signal to output a PCI-Express frame format signal.

The delimiter control signal may be a start delimiter control signal or an end delimiter control signal. In this case, the framing data output uni2 90 may multiplex an MSB of the framing base signal on the basis of the start delimiter control signal or may multiplex an LSB of the framing base signal on the basis of the end delimiter control signal to output a PCI-Express frame format signal.

The framing control signal may be a pad control signal for insertion of a pad signal. The framing data buffer 290 may multiplex a corresponding lane of the framing base signal on the basis of the pad control signal to output a PCI-Express frame format signal.

A configuration of the framing data buffer 290 will now be described in more detail.

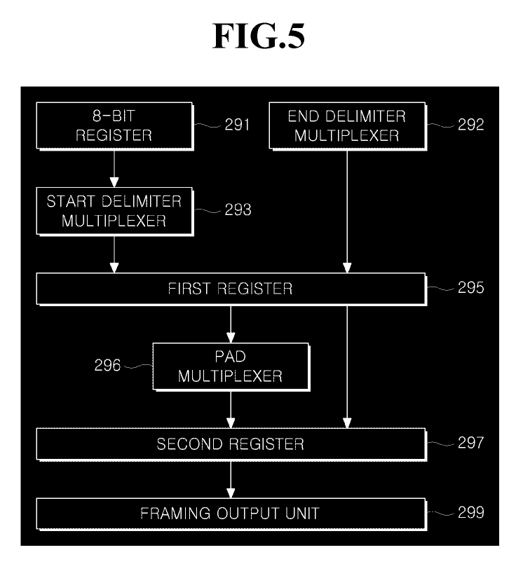

FIG. 5 is a block diagram of a framing data buffer of a 4× framer/deframer module for PCI-Express for framing according to an embodiment of the present invention.

As shown, the framing data buffer includes an 8-bit register 291, an end delimiter multiplexer 292, a start delimiter multiplexer 293, a first register 295, a pad multiplexer 296, a second register 297, and a framing buffer 299.

The 8-bit register 291 is configured to store an MSB of a framing base signal of the framing base signal generator 250.

The end delimiter multiplexer 292 is configured to multiplex an LSB of the framing base signal on the basis of a framing control signal of the framing controller 270.

The start delimiter multiplexer 293 is configured to multiplex an MSB of the framing base signal of the 8-bit register 291 or the framing base-signal generator 250 on the basis of the framing control signal.

The first register 295 is configured to store a framing intermediate signal obtained by multiplexing the framing base signal using the end delimiter multiplexer 292 and the start delimiter multiplexer 293.

The pad multiplexer 296 is configured to multiplex a portion of lanes of the framing intermediate signal of the first register 295 on the basis of the framing control signal.

The second register 297 is configured to store a framing result signal obtained by multiplexing the framing intermediate signal by the pad multiplexer 296.

The framing buffer 299 is configured to output a 32-bit PCI-Express frame format signal from the framing result signal of the second register 297.

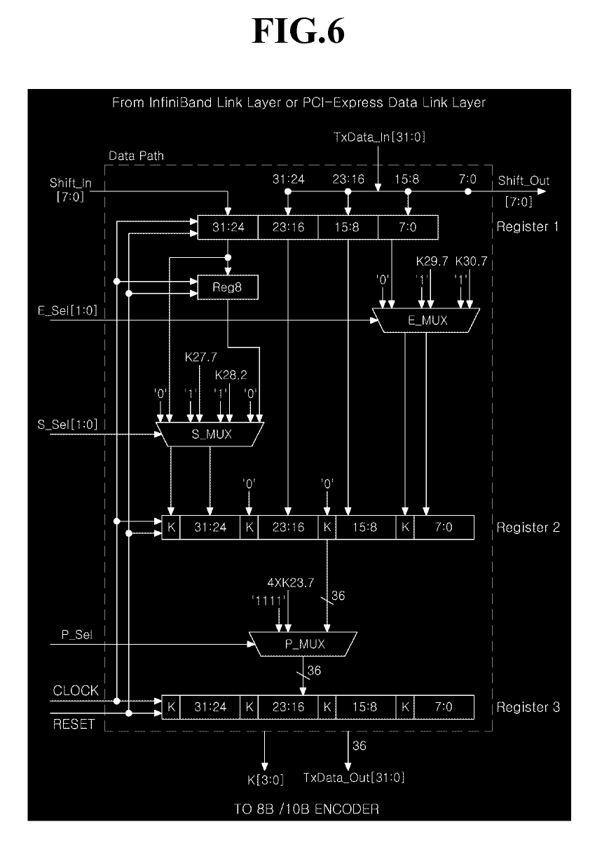

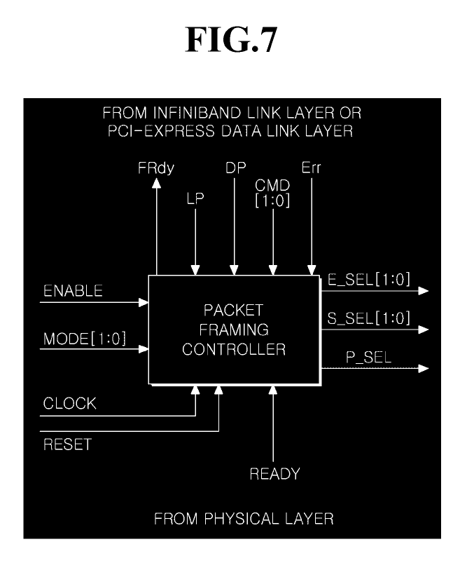

FIGS. 6 and 7 are views showing an implementation example of a 4× framer/deframer module for PCI-Express for framing according to an embodiment of the present invention.

FIG. 6 shows a design excluding the framing controller 270, and FIG. 7 shows a design of the framing controller 270.

Referring to FIG. 6, framing is performed by using a plurality of registers and a multiplexer MUX for insertion of a delimiter or a pad.

Referring to FIG. 7, the framing controller 270 generates a signal for selection of a delimiter, a pad, and data in the multiplexer MUX shown in the design of FIG. 6 in response to status and control signals of an upper layer and a lower layer.

Also, for expansion to 8× or more and arrangement thereof, an 8-bit shift-in signal Shift_In[7:0] and a shift-out signal Shift_Out[7:0] are used, and an 8-bit register Reg8 is used to place an LSB at a position of an MSB in the next clock at the time of arrangement.

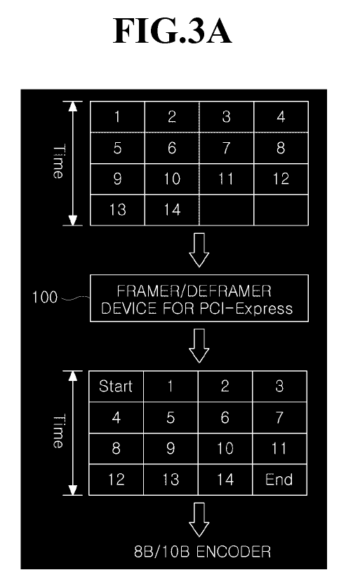

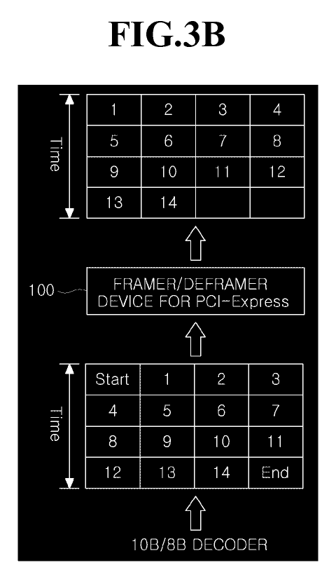

In the case of 4× framing, i.e., the case where a single 4× framer/deframer module for PCI-Express operates, the shift-in signal and the shift-out signal are connected, thereby performing an operation as shown in FIG. 3A.

An multiplexers S_MUX, an E_MUX, and a P_MUX perform multiplexing such that a start delimiter, an end delimiter and a PAD are respectively selected in response to control signals E_Sel, S_Sel and P_Sel, i.e., an end delimiter control signal, a start delimiter control signal, and a pad control signal, and are inserted in a register Register 2 or 3.

The arrangement is performed by the 8-bit register Reg8 for a path change and one clock delay, and the selection and insertion of the delimiter and pad are performed within one clock by pipelining, so that a frame can be generated after 3 clock cycles.

The 8-bit register Reg8 corresponds to the 8-bit register 291 of FIG. 5, the register Register 1 corresponds to the framing base-signal generator 250 of FIG. 5, the register Register 2 corresponds to the first register of FIG. 5, and the register Register 3 corresponds to the second register 299 of FIG. 5.

Also, the multiplexers S_MUX, the E_MUX, the P_MUX correspond to the start delimiter multiplexer 293, the end delimiter multiplexer 292, and the pad multiplexer 296 of FIG. 5, respectively.

In the design of FIG. 7, to control the 4× framer/deframer module for PCI-Express for framing according to an embodiment of the present invention, and particularly to provide expansibility and reconfigurability, mode setting is required to determine a relationship with another 4× framer/deframer module for PCI-Express. That is, the 4× framer/deframer module for PCI-Express for framing may operate independently. Also, in a state where a plurality of 4× framer/deframer module for PCI-Express, the 4× framer/deframer module for framing may act as the first 4× framer/deframer module for PCI-Express, an intervening 4× framer/deframer module for PCI-Express, or the last 4× framer/deframer module for PCI-Express.

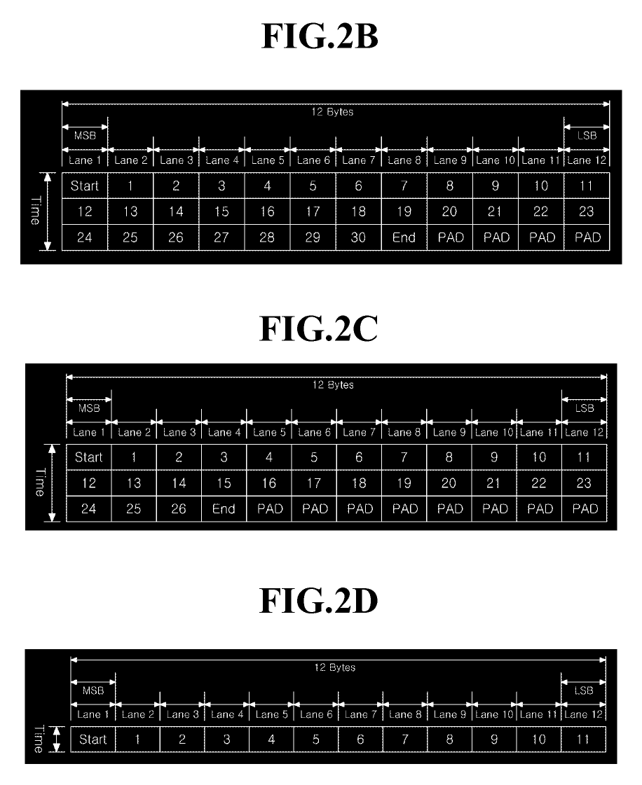

In this case, as shown in FIGS. 2A through 2D, in order to construct an entire frame format in units of 4×, 4× framer/deframer modules for PCI-Express at their respective positions perform slightly different functions.

Accordingly, a command signal CMD is added to perform proper functions according to a mode signal MODE. Names, types, and functions of signals including the mode signal MODE and the command signal CMD in an actual design example of the 4× framer/deframer module for PCI-Express according to an embodiment of the present invention shown in FIG. 6 or 7 will now be described in detail.

A reset signal RESET is the input of the 4× framer/deframer module for PCI-Express, and is a signal for changing registers and signals within the 4× framer/deframer module for PCI-Express into a default state.

A clock signal CLOCK is the input of the 4× framer/deframer module for PCI-Express, and a clock signal acting as a base of an operation of the 4× framer/deframer module for PCI-Express.

An enable signal ENABLE is the input of the 4× framer/deframer module for PCI-Express, and is an active high signal for enabling the 4× framer/deframer module for PCI-Express.

A mode signal MODE[1:0] is the input of the 4× framer/deframer module for PCI-Express. For example, if a mode signal is “00”, it indicates that the 4× framer/deframer module for PCI-Express is used only for 4× framing/deframing. If a mode signal is “01”, “10” or “11”, it indicates, for example, that a plurality of 4× framer/deframer modules for PCI-Express are linked to be used for 8× framing/deframing. For example, a mode signal “01” indicates that the corresponding 4× framer/deframer module for PCI-Express is linked first, a mode signal “10” indicates that the corresponding 4× framer/deframer module for PCI-Express is an intervening 4× framer/deframer module for PCI-Express, and a mode signal “11” indicates that the corresponding 4× framer/deframer module for PCI-Express is the last module that is linked.

A ready signal Ready is the input of the 4× framer/deframer module for PCI-Express, and is an active high signal that indicates that an 8b/10b encoder and a physical layer are ready.

A frame ready signal Frdy is the output of the 4× framer/deframer module for PCI-Express, and is an active high signal that indicates that the 4× framer/deframer module for PCI-Express is ready to receive packet data from an upper layer.

An LP signal LP is the input of the 4× framer/deframer module for PCI-Express, and is an active high signal that indicates that input data is a data link packet of the PCI-Express.

A UP signal UP is the input of the 4× framer/deframer module for PCI-Express, and is an active high signal that indicates input data is a transaction link packet of the PCI-Express.

A command signal CMD[1:0] is the input of the 4× framer/deframer module for PCI-Express, and is a signal that indicates an operational module of the 4× framer/deframer module for PCI-Express. For example, if a command signal is “00”, it indicates that input data is first 4 bytes, i.e., that a start delimiter must be inserted, and if a command signal is “01”, it indicates that input data is the last 4 bytes of a packet, i.e., that an end delimiter is must be inserted. Also, if a command signal is “10”, it indicates that input data is intervening 4 bytes of the data, i.e., that only arrange needs to be performed, and if a command signal “11”, it indicates that input data is not valid, i.e., that padding must be performed.

An error signal Err is the input of the 4× framer/deframer module for PCI-Express, and is an active high signal indicating that a packet error occurs.

Data TxData_In[31:0] is the input of the 4× framer/deframer module for PCI-Express, and is unframed and unarranged packet data which is transmitted from the upper layer.

A shift-in signal Shift_In[7:0] is the input of the 4× framer/deframer module for PCI-Express, and is a signal for arrangement of packets input from another 4× framer/deframer module for PCI-Express disposed previously.

In this case, if the mode signal is “00”, the shift-in signal Shift-In[7:0] is connected to a shift-out signal Shift_Out[7:0] of the 4× framer/deframer module for PCI-Express. However, in other cases, the shift-in signal Shift-In[7:0] is connected to a shift-out signal Shift_Out[7:0] of another 4× framer/deframer module for PCI-Express disposed, for example, at the middle or last portion.

The shift-out signal Shift-Out[7:0] is the output of the 4× framer/deframer module for PCI-Express, and is a signal for arrangement of packets to be output to another 4× framer/deframer module for PCI-Express disposed later.

In this case, if the mode signal is “00”, the shift-out signal Shift-Out[7:0] is connected to a shift-in signal Shift_In[7:0] of the 4× framer/deframer module for PCI-Express. However, in other cases, the shift-out signal Shift-Out[7:0] is connected to a shift-in signal Shift_In[7:0] of another 4× framer/deframer module for PCI-Express disposed, for example, at the middle or last portion.

A signal K[3:0] is the output of the 4× framer/deframer module for PCI-Express, and is a signal that indicates a specific control character.

For example, if data TxData_In[31:24] is a start delimiter or a pad, K[3]=‘1’, and if not, K[3]=‘0’.

For example, if data TxData_In[23:16] is a pad, K[2]=‘I’, and if not, K[2]=‘0’.

For example, if data TxData_In[15:8] is a pad, K[1]=‘1’, and if not, K[1]=‘0’.

For example, if data TxData_In[7:0] is an end delimiter or a pad, K[0]=‘1’, and if not, K[0]=‘0’.

Data TxData_Out[31:0] is the output of the 4× framer/deframer module for PCI-Express, and is frame data that is framed and arranged for 4 8b/10b encoders.

The 4× framer/deframer module for PCI-Express for framing according to an embodiment of the present invention described above with reference to FIGS. 4 through 7 is usable in the PCI-Express, and allows 4× framing expansible to 8× or more multiple lanes. Also, the 4× framer/deframer module for PCI-Express includes delimiter and pad processing functions, and arrangement functions for configuration of a frame format, and allows expansion and reconfiguration.

A 4× framer/deframer module for PCI-Express for deframing according to an embodiment of the present invention can be configured.

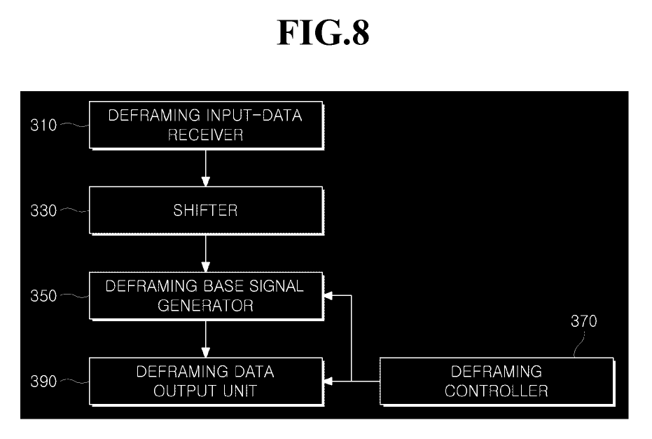

FIG. 8 is a block diagram of a 4× framer/deframer module for PCI-Express for deframing according to an embodiment of the present invention.

As shown, the 4× framer/deframer module for PCI-Express for deframing according to an embodiment of the present invention includes a deframing input-data receiver 310, a shifter 330, a deframing base signal generator 350, a deframing controller 370, and a deframing data buffer 390.

The deframing input-data receiver 320 is configured to receive a 32-bit PCI-Express frame format input signal.

The shifter 330 is configured to shift the 32-bit PCI-Express frame format input signal received by the deframing input-data receiver 310.

In this case, an MSB of the 32-bit PCI-Express frame format input signal is output as an 8-bit shift-out signal, and the remaining 24-bit shift signal is output.

The deframing base signal generator 350 is configured to receive an 8-bit shift-in signal and add the 24-bit shift signal of the shifter 330 as an LSB to generate a 32-bit deframing base signal.

That is, an LSB of the 32-bit deframing base signal is the 8-bit shift-in signal, and 3 bytes including an MSB are set to last 3 bytes of the 32-bit data input signal received by the deframing input-data receiver 310.

The deframing base signal generator 350 is configured to store and output the deframing base signal, and thus can be implemented by using a 32-bit register.

The deframing controller 370 is configured to generate a deframing control signal for controlling deletion of a delimiter or a pad signal with respect to the deframing base signal of the deframing base signal generator 350.

When the 4× framer/deframer module for PCI-Express according to an embodiment of the present invention is singly used, an 8-bit shift-out signal and an 8-bit shift-in signal may be identical.

That is, the 8-bit shift-out signal of the shifter 330 can be used as the 8-bit shift-in signal. In this case, the deframing controller 370 can control such that the 8-bit shift-out signal of the shifter 330 is input to the deframing base signal generator 350 as the 8-bit shift-in signal.

Also, a plurality of 4× framer/deframer modules for PCI-Express according to an embodiment of the present invention may be connected and used particularly for multiple lanes of, e.g., 8× or 16×. In this case, the deframing controller 270 can control such that an 8-bit shift-out signal of another external 4× framer/deframer module for PCI-Express is input to the deframing base signal generator 350 as the 8-bit shift-in signal.

The deframing controller 270 may generate a deframing control signal on the basis of a mode control signal generated according to deposition of the 4× PCI-express framer/deframer modules. The mode control signal may refer to, for example, a mode signal MODE[1:0] described with reference to FIG. 7.

Also, the deframing controller 270 can send status information of a deframing data signal to a PCI-Express data link layer or a transaction layer.

The deframing data duffer 390 operates a deframing base signal of the deframing base signal generator 350 on the basis of the deframing control signal of the deframing controller 370 to output a 32-bit deframing data signal.

For example, the deframing control signal of the deframing controller 270 may be a shift control signal for deletion of the delimiter or the pad signal.

In this case, the deframing data buffer 390 multiplexes an LSB of the deframing base signal on the basis of a shift control signal to output a deframing data signal.

The deframing data buffer 390 will now be described in more detail.

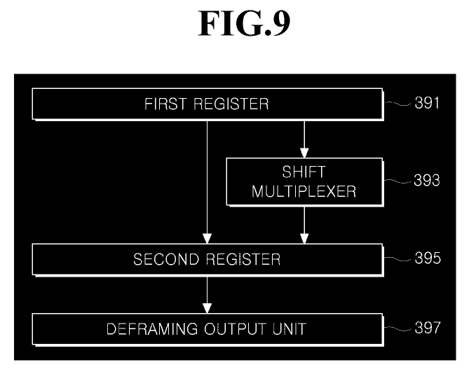

FIG. 9 is a block diagram of a deframing data buffer of a 4× framer/deframer module for PCI-Express for deframing according to an embodiment of the present invention.

As shown, the deframing data buffer of the 4× framer/deframer module for PCI-Express for deframing according to an embodiment of the present invention includes a first register 391, a shift multiplexer 393, a second register 395, and a deframing buffer 397.

The first register 391 is configured to store a deframing base signal.

The shift multiplexer 393 is configured to multiplex an LSB of the deframing base signal of the deframing base signal generator 350 and an LSB of the first register 391 on the basis of a deframing control signal of the deframing controller 370.

The second multiplexer 396 is configured to store the output of the shift multiplexer 393 as a deframing data signal.

The second register 395 is configured to store as a deframing data signal, a signal obtained by multiplexing the deframing base signal of the first register 391 by the shift multiplexer 393.

The deframing buffer 397 serves as an interface outputting the deframing data signal of the second register 395.

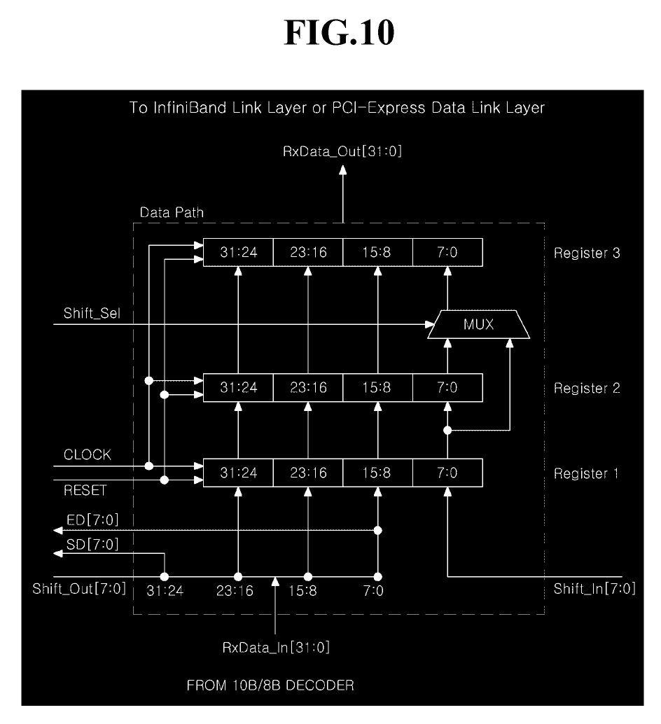

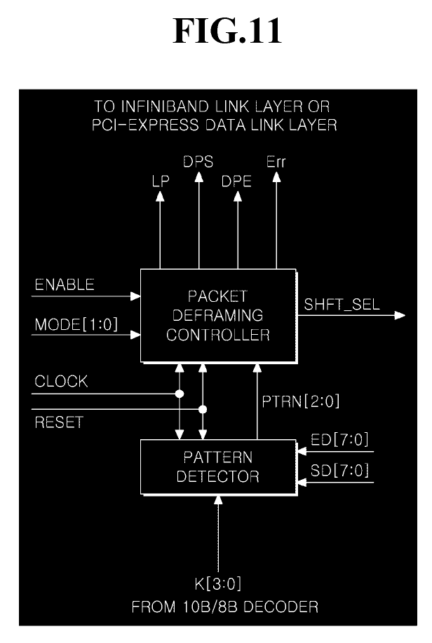

FIGS. 10 and 11 are views showing an implementation example of the 4× framer/deframer module for PCI-Express for deframing according to an embodiment of the present invention.

FIG. 10 shows an exemplary design excluding the deframing controller 370, and FIG. 11 shows an exemplary design of the deframing controller 270.

Referring to FIG. 10, deframing is performed by using a plurality of registers, and a multiplexer MUX for deletion of a delimiter or a pad.

Referring to FIG. 11, the deframing controller 270 detects a pattern, and sends a status signal and a control signal to an upper layer or a lower layer on the basis of the detected pattern.

For expansion and arrangement of 8× or more, an 8-bit shift-in signal Shift_In[7:0] and a shift-out signal Shift_Out[7:0] signal are used.

In the case of 4× deframing, i.e., the case where a single 4× framer/deframer module for PCI-Express operates, the shift-in signal and the shift-out signal are connected, so that an operation as shown in FIG. 3B can be performed.

A deframing control signal Shift-Sel serves as a base for shift selection in the multiplexer MUX for deleting an end delimiter, a start delimiter, and a pad.

In FIG. 10, Register 1 corresponds to the deframing base signal generator 350 of FIG. 8, Register 2 corresponds to the first register 391 of FIG. 9, and Register 3 corresponds to the second register 395 of FIG. 9. The multiplexer MUX corresponds to the shift multiplexer 393 of FIG. 9.

The 4× framer/deframer module for PCI-Express for deframing according to an embodiment of the present invention described with reference to FIGS. 8 through 11 is usable in the PCI-Express, and allows 4× deframing expansible to 8× or more multiple lanes. Also, the 4× framer/deframer module for PCI-Express for deframing according to an embodiment of the present invention includes delimiter and pad processing functions, and a rearrangement function for frame format conversion, and allows expansion and reconfiguration.

Test results of the 4× framer/deframer module for PCI-Express according an embodiment of the present invention described with reference to FIGS. 4 through 11 are as follows.

At the physical layer of the PCI-Express, a single lane, i.e., a 1× lane operates at 2.5 Gbps. Accordingly, an upper block of an 8b/10b encoder/decoder that provides an input signal of the 4× framer/deframer module for PCI-Express or receives an output signal must operate at 8 bits and 250 MHz.

For this reason, not only the framing/deframing but also a processing rate must be importantly considered in designing the 4× framer/deframer module for PCI-Express according to an embodiment of the present invention. That is, the 4× PCI Express framer/deframer module must be operable at conditions of 32 bits and 250 MHz, and such performance must be maintained even when expansion to 8× or more is made.

In the 4× framer/deframer module for PCI-Express according to an embodiment of the present invention, a multiplexer MUX is most limited in speed improvement.

In the case of deframing, the multiplexer uses a 2:1 multiplexer with one input bus width of 8 bits, which does not cause any problem. In the case of framing, a multiplexer for a start delimiter, a multiplexer for an end delimiter, and a multiplexer for a pad each is a 4:1 multiplexer with one input bus width of 9 bits, or with one input bus width of 36 bits.

For this reason, if synthesis is performed by using, for example, a field programmable gate array (FPGA) design tool, various logic cells or look-up tables (LUT) are used, increasing an operation delay time.

In the present invention, timing analysis was performed after synthesis by using a common library of a 0.25 μm process under a test environment using a synthesizing took of Synopsys.

The analysis result revealed that both 4× framing and 4× deframing are normally performed at 250 MHz.

Also, a PCI-Express framer/deframer device for 8 ×, 16×, 32× or more multiple lanes can be configured by connecting a plurality of 4× framer/deframer module for PCI-Express for framing/deframing according to an embodiment of the present invention.

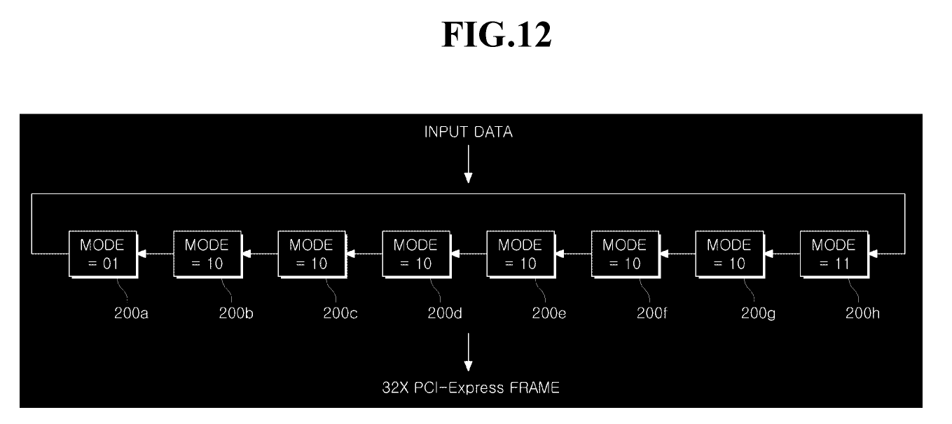

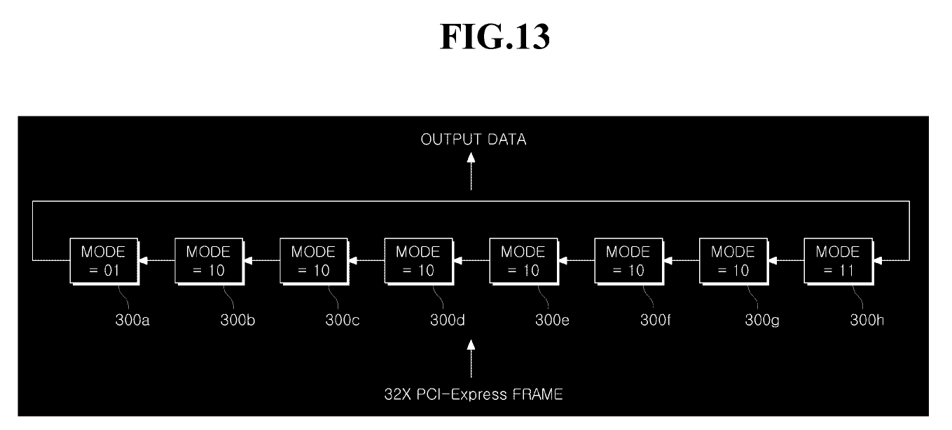

FIG. 12 shows an implementation example of a 32×PCI-Express framer/deframer device configured by connecting eight 4× framer/deframer modules for PCI-Express for framing according to an embodiment of the present invention.

As shown, the eight 4× framer/deframer modules for PCI-Express 200a through 200h for framing are connected into a chain type, and are configured such that a shift-out signal of each of the 4× framer/deframer modules 200a through 200h is applied as a shift-in signal to a neighboring 4× framer/deframer module PCI-Express.

Also, a mode signal MODE is set differently according to a position of each of the 4× framer/deframer modules 200a through 200h. Description of the mode signal MODE may refer to description made above with reference to FIG. 7.

FIG. 13 is a view showing an implementation example of a 32× PCI-Express framer/deframer device configured by connecting eight 4× framer/deframer modules for PCI-Express for deframing according to an embodiment of the present invention.

As shown, the eight 4× framer/deframer modules 300a through 300h for deframing are connected into a chain type, and are constructed such that a shift-out signal of each of the 4× framer/deframer modules 300a through 300h is applied as a shift-in signal to a neighboring 4× framer/deframer module for PCI-Express.

Also, a mode signal MODE is set differently according to a position of each of the 4× framer/deframer modules 300a through 300h. Description of the mode signal MODE may refer to description made above with reference to FIG. 7.

Even in the case of designing a 32× framer/deframer device having an expanded structure configured by using the 4× framer/deframer modules 200a through 200h or 300a through 300h as shown in FIGS. 12 and 13, the timing analysis result after synthesis revealed that normal operation is achieved at 250 MHz.

As described above, according to the present invention, in the PCI-Express for high-rate data processing, delimiter and pad processing, and 4× framer shifting and arrangement/reverse arrangement for framing/deframing a frame format are performed to achieve a structure that facilitates reconfiguration and expansion, for example, a pipeline structure, so that the 4× framer/deframer module can operate without delay within a 250 MHz clock even when expansion to 32× is made.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A 4× framer/deframer module for PCI-Express, the module for framing, comprising:
a framing input-data receiver configured to receive a 32-bit data input signal;
a shifter configured to shift the 32-bit data input signal, and output a 24-bit shift signal and an 8-bit shift-out signal, which is a least significant byte (LSB) of the 32-bit data input signal;
a framing base-signal generator configured to receive an 8-bit shift-in signal, designate the 8-bit shift-in signal as a most significant byte (MSB), and add the 24-bit shift signal of the shifter thereto to generate a 32-bit framing base signal;
a framing controller configured to generate a framing control signal for controlling insertion of a delimiter or a pad signal with respect to the framing base signal; and
a framing data buffer configured to operate the framing base signal on the basis of the framing control signal to output a 32-bit PCI-Express frame format signal.

2. The module of claim 1, wherein the framing controller controls such that the 8-bit shift-out signal is input as the 8-bit shift-in signal.

3. The module of claim 1, wherein the framing controller controls such that an 8-bit shift-out signal of another external 4× framer/deframer module for PCI-Express is input as the 8-bit shift-in signal.

4. The module of claim 1, wherein the framing control signal comprises a delimiter control signal for insertion of the delimiter,
wherein the framing data buffer multiplexes a corresponding lane of the framing base signal on the basis of the delimiter control signal to output the PCI-Express frame format signal.

5. The module of claim 4, wherein the delimiter control signal is a start delimiter control signal, or an end delimiter control signal
wherein the framing data buffer multiplexes an MSB of the framing base signal on the basis of the start delimiter control signal, or multiplexes an LSB of the framing base signal on the basis of the end delimiter control signal to output the PCI-Express frame format signal.

6. The module of claim 1, wherein the framing control signal comprises a pad control signal for insertion of the pad signal,
wherein the framing data buffer multiplexes a corresponding lane of the framing base signal on the basis of the pad control signal to output the PCI-Express frame format signal.

7. The module of claim 1, wherein the framing controller generates the framing control signal on the basis of a mode control signal that is generated according to disposition of the 4× framer/deframer module for PCI-Express.

8. The module of claim 1, wherein the framing controller generates the framing control signal on the basis of a control signal from a PCI-Express data link layer or a transaction layer.

9. The module of claim 1, wherein the framing base signal generator is a 32-bit register.

10. The module of claim 1, wherein the framing data buffer comprises:
an 8-bit register configured to store an MSB of the framing base signal;
an end delimiter multiplexer configured to multiplex an LSB of the framing base signal on the basis of the framing control signal;
a start delimiter multiplexer configured to multiplex the MSB of the 8-bit resistor or the framing base signal on the basis of the framing control signal;
a first register configured to store a framing intermediate signal that is obtained by multiplexing the framing base signal using the end-delimiter multiplexer and the start delimiter multiplexer;
a pad multiplexer configured to multiplex a portion of lanes of the framing intermediate signal on the basis of the framing control signal;
a second register configured to store a framing result signal obtained by multiplexing the framing intermediate signal using the pad multiplexer; and
a framing buffer configured to output the 32-bit PCI-Express frame format signal from the framing result signal of the second register.

11. A framer/deframer device for PCI-Express, the device for framing, comprising a plurality of 4× framer/deframer modules for PCI-Express of claim 1,
wherein the plurality of 4× framer/deframer modules for PCI-Express are connected into a chain type such that a shift-out signal of the 4× framer/deframer module for PCI-Express is applied as a shift-in signal of the neighboring 4× framer/deframer module for PCI-Express.

12. A 4× framer/deframer module for PCI-Express, the module for deframing, comprising:
a deframing input-data receiver configured to receive a 32-bit PCI-Express frame format input signal;
a shifter configured to shift the 32-bit PCI-Express frame format input signal to output a most significant byte (MSB) of the 32-bit PCI-Express frame format input signal as an 8-bit shift-out signal, and output a remaining 24-bit shift signal;
a deframing base-signal generator configured to receive an 8-bit shift-in signal and add the 8-bit shift-in signal as a least significant bit (LSB) to the 24-bit shift signal to generate a 32-bit deframing base signal;
a framing controller configured to generate a deframing control signal for controlling deletion of a delimiter or a pad signal with respect to the deframing base signal; and
a deframing data buffer configured to operate the deframing base signal on the basis of the deframing control signal to output a 32-bit deframing data signal.

13. The module of claim 12, wherein the deframing controller controls such that the 8-bit shift-out signal is input as the 8-bit shift-in signal.

14. The module of claim 12, wherein the deframing controller controls such that an 8-bit shift-out signal of another external 4× framer/deframer module for PCI-Express is input as the 8-bit shift-in signal.

15. The module of claim 12, wherein the deframing control signal comprises a shift control signal for deletion of the delimiter or the pad signal,
wherein the deframing data buffer multiplexes an LSB of the framing base signal on the basis of the shift control signal to output the deframing data signal.

16. The module of claim 12, wherein the deframing controller generates the deframing control signal on the basis of a mode control signal that is generated according to deposition of the 4× framer/deframer module for PCI-Express.

17. The module of claim 12, wherein the deframing controller transmits status information of the deframing data signal to a PCI-Express data link layer or a transaction layer.

18. The module of claim 12, wherein the deframing base signal generator is a 32-bit register.

19. The module of claim 12, wherein the deframing data buffer comprises:
a first register configured to store the deframing base signal;
a shift multiplexer configured to multiplex an LSB of the deframing base signal and an LSB of the first register on the basis of the deframing control signal;
a second register configured store, as the deframing data signal, a signal obtained by multiplexing the deframing base signal of the first register using the shift multiplexer; and
a deframing buffer configured to output the deframing data signal.

20. A framer-deframer device for PCI-Express, the device for deframing, comprising a plurality of 4× framer/deframer modules for PCI-Express of claim 12,
wherein the plurality of 4× framer/deframer modules for PCI-Express are connected into a chain type such that a shift-out signal of the 4× framer/deframer module for PCI-Express is applied as a shift-in signal of the neighboring 4× framer/deframer module for PCI-Express.
